(19) United States
(12) Patent Application Publication
(10) Pub. No.: US 2023/0261774 A1
(43) Pub. Date: Aug. 17, 2023

(54) SYSTEMS AND METHODS OF ANOMALY DETECTION IN ANTENNA NETWORKS USING VARIATIONAL AUTOENCODERS

(71) Applicant: L3Harris Technologies, LLC, Melbourne, FL (US)

(72) Inventors: Mark Rahmes, Melbourne, FL (US); Jennifer Spicer, Westminster, MD (US); Christopher Jason Berger, Leesburg, VA (US); Ralph Smith, Oak Hill, VA (US); Dustin Ellsworth, Fredonia, KY (US); Timothy Bruce Faulkner, Palm Bay, FL (US); Shoaib Shaikh, Windermere, FL (US)

(21) Appl. No.: 17/672,251

(22) Filed: Feb. 15, 2022

(51) Int. Cl. H04B 17/391; H04B 17/23

(52) U.S. Cl. CPC H04B 17/3912; H04B 17/23

(57) ABSTRACT

Systems and methods for detecting anomalies in antenna systems (e.g., air traffic control surveillance systems), include a processor receiving antenna status information. A variational autoencoder receives and optimizes the antenna status information and determines whether it qualifies as an anomaly. Optimized antenna status information is compared to either non-anomalous or anomalous antenna status data in a latent space of the variational autoencoder. The latent space preferably includes an n-D point scatter plot and hidden vector values. The processor optimizes the antenna status information by generating a plurality of probabilistic models of the antenna status information and determining which of the plurality of models is optimal. A game theoretic optimization is applied to the plurality of models, and the best model is used to generate the n-D point scatter plot in latent space. An image gradient sobel edge detector preprocesses the antenna status information prior to optimization.

### BACKGROUND OF THE INVENTION

### Field of the Invention

The invention is directed to anomaly detection in antenna networks. More specifically, the invention is directed to systems and methods for efficiently and effectively detecting anomalies in antenna networks such as those of Automatic Dependent Surveillance-Broadcast (ADS-B) systems and other terrestrial systems (e.g., cellular communications systems) by means of a variational autoencoder.

### Description of Related Art

The ADS-B system includes over 7000 antennas and related equipment across the US. It would be desirable to be able to autonomously monitor those 7000+ radio channels for any deviations trending away from nominal performance. These deviations are most often the result of impacts to the antennas (e.g. high winds, obstructions, bird nests) and/or impacts to transmission lines (e.g. loose connectors, eroded shielding, water breach).

The conventional way to measure a gain pattern is by using a radio-isolated test range, and moving a calibrated source, measuring the coupled power. The problems being addressed herein are different than determining the nominal gain pattern of an antenna. It must be known how a fielded system is performing.

Conventionally, the average gain pattern is manually reviewed and visually inspected for attenuated lobes or large deviations in azimuth. Results are filtered by thresholds. Date range, radio, and thresholds are manually entered, average gain and azimuth are computed and shown in table format, and the operator visually inspects the table for threshold violations.

There are a number of deficiencies with this approach. First, this is a manual process that is exceptionally labor intensive (there are 7000+ radio channels). As a result, detection of antenna anomalies is delayed by months after initial occurrence, leading to poor coverage and even dead zones in the system. Additionally, appropriate thresholds for each antenna are unknown, because a common threshold cannot be universally applied to all antennas. As a result, thresholds are guessed systemwide, leading to missed anomalies.

Accordingly, there is a long felt need to provide a way of determining when an out of the ordinary occurrence in an antenna network environment is a sufficiently significant incident to warrant a response.

There is another long felt need to provide a way of autonomously monitoring a large, widely distributed antenna network in an efficient and accurate manner.

### SUMMARY OF THE INVENTION

The above and other objects are fulfilled by the invention, which includes antenna network anomaly detection systems and methods and non-transitory computer-readable storage media including one or more programs for executing a model of detecting anomalies in an antenna network. The invention utilizes artificial intelligence and machine learning (AI/ML) to distinguish those cases which require investigation from other events not requiring further investigation. By significantly reducing the false positives using an AI/ML engine, an analyst can focus on investigating the events related to an incident rather than ignoring those incidents. Additionally, the risks and repercussions of an incident will be drastically reduced if an incident is detected and addressed early.

In an embodiment, the invention includes an antenna network anomaly detection system. A plurality of antennas are provided, at least a portion of the plurality of the antennas generating antenna status information. A processor is in communication with at least one of the antennas of the portion of the plurality of the antennas and receiving the antenna status information. The processor operates a variational autoencoder that receives the antenna status information; optimizes the received antenna status information; and determines or enables a user to determine whether the antenna status information qualifies as an anomaly that requires a response. In an embodiment, the processor compares the optimized antenna status information to at least one of non-anomalous antenna status data or anomalous antenna status data in a latent space of the variational autoencoder. In an embodiment, the latent space includes an n-D point scatter plot; the further the optimized antenna status information is from the non-anomalous antenna status data in the latent space, the greater the likelihood the antenna status information represents an anomaly. In an embodiment, the latent space includes a 3-D point scatter plot that includes hidden vector values.

In an embodiment, the processor optimizes the antenna status information by generating a plurality of probabilistic models of the antenna status information and determining which of the plurality of models is optimal. In an embodiment, the processor determines which of the plurality of models is optimal by applying a game theoretic optimization to the plurality of models and selecting which of the plurality of models to use to generate the n-D point scatter plot in latent space. In an embodiment, the plurality of models includes at least two of Adam, Stochastic Gradient Descent with Momentum (SGDM), or Root Mean Squared Propagation (RMSProp).

In an embodiment, the antenna network anomaly detection system further includes

a display and a user interface, the user interface enabling a user to select a data sample from the antenna status information and to see where the data sample is located in the latent space n-D point scatter plot.

In an embodiment, the processor includes an image gradient sobel edge detector that preprocesses the antenna status information prior to optimizing the antenna status information. In an embodiment, the image gradient sobel edge detector is configured to return a floating-point edge metric.

In an embodiment, the plurality of antennas comprises an air traffic control surveillance system. In an embodiment, the antenna status information comprises at least one of a gain pattern for each antenna or the average gain pattern over time for each antenna.

The invention also includes a method of detecting antenna anomalies in a plurality of antennas. The method includes the steps of: generating antenna status information for at least a portion of the plurality of antennas; receiving the antenna status information at a processor in communication with at least one of the antennas of the portion of the plurality of antennas; and operating a variational autoencoder on the processor that is configured for receiving the antenna status information; optimizing the received antenna status information; and determining or enabling a user to determine whether the antenna status information qualifies as an anomaly that requires a response. In an embodiment, the method further includes the step of comparing, via the processor, the optimized antenna status information to at least one of non-anomalous antenna status data or anomalous antenna status data in a latent space of the variational autoencoder. In an embodiment, the latent space includes an n-D point scatter plot; the further the optimized antenna status information is from the non-anomalous antenna status data in the latent space, the greater the likelihood the antenna status information represents an anomaly. In an embodiment, the latent space includes a 3-D point scatter plot that includes hidden vector values. In an embodiment, the optimizing step further comprises the steps of: generating, via the processor, a plurality of probabilistic models of the antenna status information; and determining, via the processor, which of the plurality of models is optimal. In an embodiment, the step of determining which of the plurality of models is optimal further comprises the steps of: applying a game theoretic optimization to the plurality of models; and selecting which of the plurality of models to use to generate the n-D point scatter plot in latent space. In an embodiment, the optimizing step is performed for at least one subset of the antenna status information.

In an embodiment, the method further includes the step of preprocessing the antenna status information prior to optimizing the antenna status information via an image gradient sobel edge detector. In an embodiment, the method further includes the step of returning a floating-point edge metric via the image gradient sobel edge detector.

In an embodiment, the method further includes the steps of implementing a 3-D p-value statistical test to measure anomaly detection accuracy; and representing the results of the 3-D p-value statistical test with Receiver Operating Characteristic (ROC) curves. In an embodiment, the implementing step further includes the steps of: selecting a 3-D view of latent space clusters that shows the most separation of test hypotheses; and calculating the probability of the most likely non-anomalous antenna status data to which received antenna status information might belong to latent space distribution.

In an embodiment, the plurality of antennas comprises an air traffic control surveillance system. In an embodiment, the antenna status information comprises at least one of a gain pattern for each antenna or the average gain pattern over time for each antenna.

The invention also includes a non-transitory computer-readable storage medium, comprising one or more programs for executing a model of detecting antenna anomalies in a plurality of antennas by use of a variational autoencoder. The model is configured to: receive antenna status information from at least a portion of the plurality of antennas; optimize the received antenna status information by use of the variational autoencoder; and determine or enable a user to determine whether the antenna status information qualifies as an anomaly that requires a response. In an embodiment, the model is further configured to compare, via the processor, the optimized antenna status information to at least one of non-anomalous antenna status data or anomalous antenna status data in a latent space of the variational autoencoder. In an embodiment, the latent space includes an n-D point scatter plot, and wherein the further the optimized antenna status information is from the non-anomalous antenna status data in the latent space, the greater the likelihood the antenna status information represents an anomaly. In an embodiment, the latent space includes a 3-D point scatter plot that includes hidden vector values.

In an embodiment, the model is further configured to optimize, via the processor, the antenna status information by generating a plurality of probabilistic models of the antenna status information and determines which of the plurality of models is optimal. In an embodiment, the model is further configured to determine, via the processor, which of the plurality of models is optimal by applying a game theoretic optimization to the plurality of models and selecting which of the plurality of models to use to generate the n-D point scatter plot in latent space.

In an embodiment, the model is further configured to preprocess the antenna status information prior to optimizing the antenna status information via an image gradient sobel edge detector. The model is further configured to return a floating-point edge metric via the image gradient sobel edge detector.

In an embodiment, the model is further configured to: implement a 3-D p-value statistical test to measure anomaly detection accuracy; and represent the results of the 3-D p-value statistical test with ROC curves. In an embodiment, the model is further configured to: select a 3-D view of latent space clusters that shows the most separation of test hypotheses; and calculate the probability of the most likely non-anomalous antenna status data to which received antenna status information might belong to latent space distribution.

In an embodiment, the plurality of antennas comprises an air traffic control surveillance system. In an embodiment, the antenna status information comprises at least one of a gain pattern for each antenna or the average gain pattern over time for each antenna.

### BRIEF DESCRIPTION OF THE DRAWINGS

FIG. 1 is a system diagram of a variational autoencoder with game theory optimization in accordance with an embodiment of the invention.

FIG. 2 is a 3-D scatter plot of the mean and variance latent space hidden vectors for several antenna patterns plus anomalous data in accordance with an embodiment of the invention.

FIG. 3 is an ensemble of ROC curves in accordance with an embodiment of the invention.

FIG. 4 is a graph of H0, no change image/pixel test samples, in accordance with an embodiment of the invention.

FIG. 5 is a graph of H1, change image/pixel test samples, in accordance with an embodiment of the invention.

FIG. 6A is an exemplary visualization tool that shows data ingest, preprocessing, reconstruction, and data compression during variational autoencoder training in accordance with an embodiment of the invention.

FIG. 6B is an exemplary visualization tool of a trained variational autoencoder detecting anomalies for use by a data analyst in accordance with an embodiment of the invention.

FIG. 7 is a block diagram of an exemplary computing environment within which various embodiments of the invention may be implemented and upon which various embodiments of the invention may be employed.

### DETAILED DESCRIPTION OF THE INVENTION AND DRAWINGS

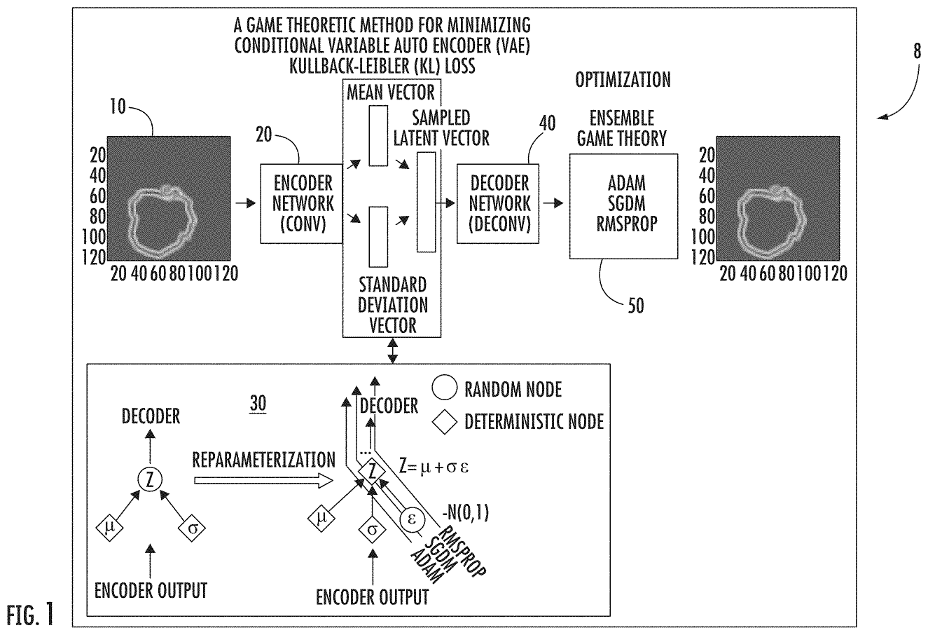

Description will now be given with reference to the attached FIGS. 1-7. It should be understood that these figures are exemplary in nature and in no way serve to limit the scope of the invention, which is defined by the claims appearing hereinbelow.

One of the key elements of the invention is a variational autoencoder (VAE). VAEs, like other autoencoders, include an encoder, a decoder, and latent space. In a typical autoencoder, the encoder learns to compress (reduce) the input data into an encoded representation, the decoder learns to reconstruct the original data from the encoded representation to be as close to the original input as possible, and the latent space is the layer that contains the compressed representation of the input data.

VAEs differ from regular autoencoders in that they do not use the encoding-decoding process simply to reconstruct an input. Instead, they impose a probability distribution on the latent space, and learn the distribution so that the distribution of outputs from the decoder matches that of the observed data. Then, they sample from this distribution to generate new data. A VAE assumes that the source data has some sort of underlying probability distribution (such as Gaussian) and then attempts to find the parameters of the distribution. A variational autoencoder is a generative system and serves a similar purpose as a generative adversarial network. One main use of a variational autoencoder is to generate new data that is related to the original source data. In the case of the instant invention, the new data is used for additional training and testing analysis.

Generally speaking, the instant invention utilizes a variational autoencoder with game theory optimization to analyze antenna gain patterns and detect anomalies. Sample data of a known antenna anomaly is obtained. Average gain over time is plotted. Normal and abnormal data are identified by visual inspection. Train/test data sets are created by plotting each data point and converting to images (e.g., .png files). The VAE is trained on these images. The VAE models each antenna's normal behavior with a gaussian surfaces in 20D latent space. The trained model is tested with a mix of normal and abnormal data. The model successfully separates normal from abnormal. Significant performance improvement is seen by taking a game theoretic approach to optimization.

FIG. 1 depicts a typical process flow 8 of an embodiment of the invention. The goal of the system is ultimately to detect or enable a user to detect anomalous behavior in an antenna. This can take the form of obstructions, bird nests, loose connectors, eroded shielding, water breach, and the like.

At step 10, data is input into the system. The data in this case can represent any aspect or aspects of the system or devices under test, including but not limited to overall performance, individual device performance, performance of a plurality of devices clustered together, etc. In the case of ADS-B, as described herein, the gain pattern for each antenna is sampled periodically at 5-degree azimuthal increments, resulting in 72 decimal numbers ranging from ˜5 dB to ˜20 dB. This data is averaged over an hour and stored in a database for later analysis.

The ADS-B antenna gain patterns are derived using received transmissions from ADS-B Targets of Opportunity (TOOs). In other words, ADS-B reports received from the ADS-B ground stations are recorded. Each report contains the position and altitude of the aircraft. Using the record signal strength, RF propagation, and a variety of assumptions, the ADS-B antenna gain patterns can be effectively reproduced with a statistically significant number of ADS-B reports. The gain pattern should not change significantly over time if the site suffers no degradation. Recording the data over time allows for the characterization of what is ‘normal’ for any antenna in the system. The concept of ‘normal’ can vary significantly from antenna to antenna due to surrounding terrain, the RF environment, and the flight patterns of ADS-B equipped aircraft. Since it is desired to measure only the antenna performance, samples are restricted to those where the RF path is above the 1st Fresnel Zone using maps developed from a digital elevation model. Given the known values, the expected signal strength is calculated based on the expected free-space path loss based on distance to the aircraft. The binning of the data into 5-degree azimuth slices is a design decision for tool processing and storing data in a database. Five-degree bin size is typically sufficient to make the desired determinations. It is not necessarily a required value; the invention contemplates using different sizes of azimuth slices as well.

In an embodiment, at step 10, an image gradient sobel edge detector is used as a preprocessing step. This preprocessing step helps the models to learn more quickly and with more accuracy. In an embodiment, the image gradient sobel edge detector is configured to return a floating-point edge metric.

At step 20, the preprocessed data is provided to the encoder of the VAE. The VAE forces input data onto a multidimensional Gaussian distribution. In an embodiment, the system preferably utilizes a 20-dimensional distribution, although other distributions can also be utilized. The system learns the means and variances of the data (20 means and variances in the previously mentioned embodiment), and the resulting distribution describes the data.

The encoder generates a compressed representation of the input data. This representation is called the hidden vector. The mean and variance from the hidden vector are sampled and learned by the convolutional neural network (CNN). Principal component analysis (PCA) of the hidden vector allows for the visualization of n-D point clusters, preferably 3-D point clusters, in the latent space. To make calculations more numerically stable, the range of possible values is increased by making the network learn from the logarithm of the variances. Two vectors are defined: one for the means, and one for the logarithm of the variances. Then, these two vectors are used to create the distribution from which to sample.

In step 30, reparameterization is used to handle sampling of the hidden vector during backpropagation (an algorithm for training neural networks). An ensemble of models are generated using three different solvers: Adam, SGDM, and RMSProp. The values from the loss function (evidence lower bound or ELBO, reconstruction, and Kullback-Leibler or KL loss, to be discussed below) can be used in a game theoretic implementation to determine the optimal model to use per test sample. The loss is used to compute the gradients of the solvers.

There are several aspects to step 30:

Custom Training Loop—Both networks (mean and variance hidden vectors) are trained with a custom training loop, and automatic differentiation is enabled;

Function Model—The function model, Gradients, takes in the encoder and decoder objects and a mini-batch of input data and returns the gradients of the loss with respect to the learnable parameters in the networks;

Sampling & Loss—The function performs this process in two steps: sampling and loss. The sampling step samples the mean and the variance vectors to create the final encoding to be passed to the decoder network;

Reparameterization—Because backpropagation through a random sampling operation is not possible, it is necessary to use the reparameterization trick. This moves the random sampling operation to an auxiliary variable, which is then shifted by the mean and scaled by the standard deviation.

The loss function has the following attributes:

Loss Step—passes the encoding generated by the sampling step through the decoder network and determines the loss, which is then used to compute the gradients. The loss in VAEs, also called the evidence lower bound (ELBO) loss, is defined as a sum of two separate loss terms: reconstruction loss+KL loss.

Reconstruction Loss—measures how close the decoder output is to the original input by using the mean-squared error (MSE).

Kullback-Leibler (KL) Divergence—measures the difference between two probability distributions. Minimizing the KL loss in this case means ensuring that the learned means and variances are as close as possible to those of the target (normal) distribution.

Practical Effect—The practical effect of including the KL loss term is to pack clusters learned due to reconstruction loss tightly around the center of the latent space, forming a continuous space from which to sample.

In step 40 onward, the decoder process generates synthetic output data. The system uses an ensemble of solvers with game theoretic implementation to create an output image with least image reconstruction error (to be described in more detail below). In step 50, as above on the encoder side, the system generates an ensemble of models using three different solvers: Adam, SGDM, and RMSProp. Game theory is used to select the optimal solution from the ensemble. The values from the loss function (ELBO, Reconstruction, and KL loss) can be used in a game theoretic implementation to determine the optimal model to use per test sample. The loss is used to compute the gradients of the solvers.

Optimization utilizes a linear program to optimally choose which deep learning model to use per data point. A reward matrix, A, is created with data image loss values for different solvers. An M×C reward matrix is constructed where M is the number of models in the ensemble (typically three) and C is the number of loss inputs (KL, ELBO, and reconstruction loss). One model is used for each solver, for a total of three models: Adam; SGDM; and RMSProp. The matrix is solved for each image. A goodness-of-fit metric is used, f(x), from the reconstruction and KL loss scores or responses. An objective function, b, is used which minimizes the cost loss function per image. An interior-point algorithm, i.e., the primal-dual method, is used, which must be feasible for convergence. The Primal Standard form used to calculate optimal solver is:
minimize f(x) s.t. (1)
Ax≤b (2)
x≥0 (3)

In an embodiment, the three types of loss are put in a table having three columns and three rows. The rows correspond to the solvers Adam, SGDM, and RMSprop; as such, the rows reflect the decision to be made. The columns are the parameters that are input, resulting in the reward matrix mentioned above. The reward matrix is fit into a linear program, and boundary conditions are set. When the linear program is run, the result informs which row has the least error. That row corresponds to one of the solvers. Thus, on a per sample basis, the solver is selected with the lowest loss or error.

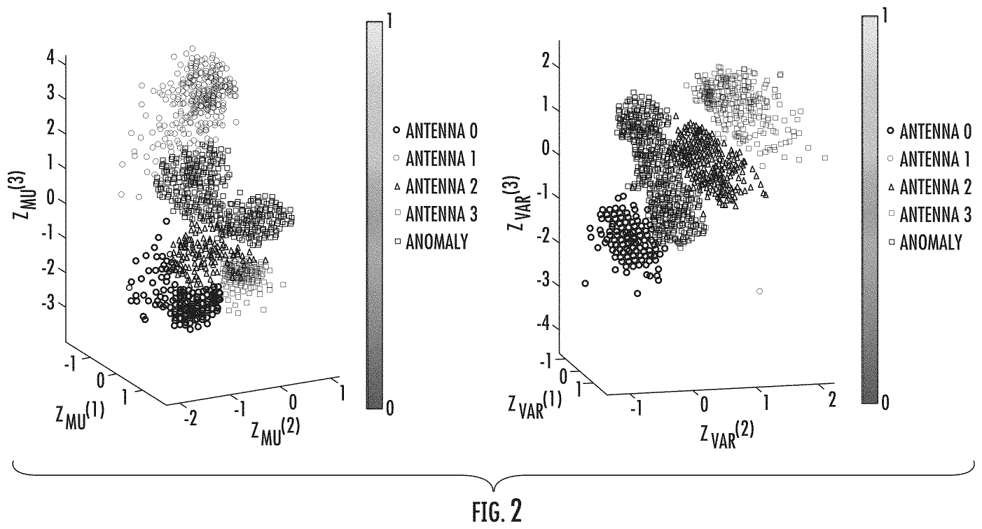

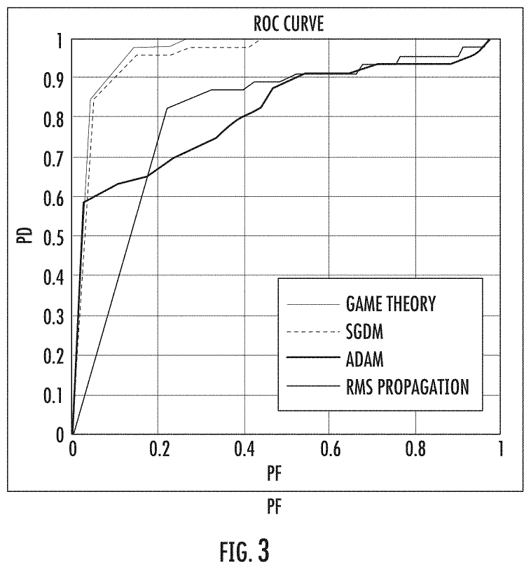

FIG. 2 depicts the abovementioned 3-D point scatter plots of the mean and variance hidden vectors for multiple antennas as well as anomalous data. It is beneficial to determine the accuracy of the output of the decoder. The invention includes accuracy assessment techniques known herein as the Z test. In it, the P test is used to determine the probability that a new test sample belongs to any one normal categorical set of data. The normal category could include an antenna channel, network security characteristics, data communication characteristics, or the like. If the likelihood of a new test sample belonging to the normal set of conditions is low, then the test sample is declared abnormal. The P test value of latent space three-dimensional point clusters, shown in FIG. 2, is then used as the metric to calculate ROC curves, shown in FIG. 3, consisting of confusion matrices of true and false positive and negative classifications.

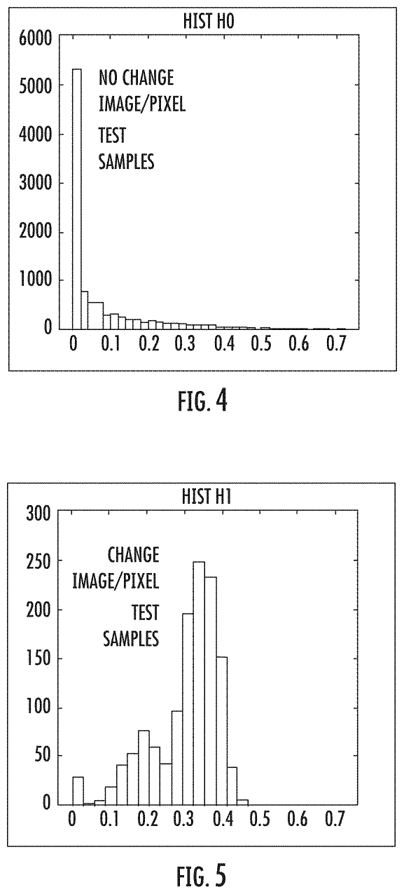

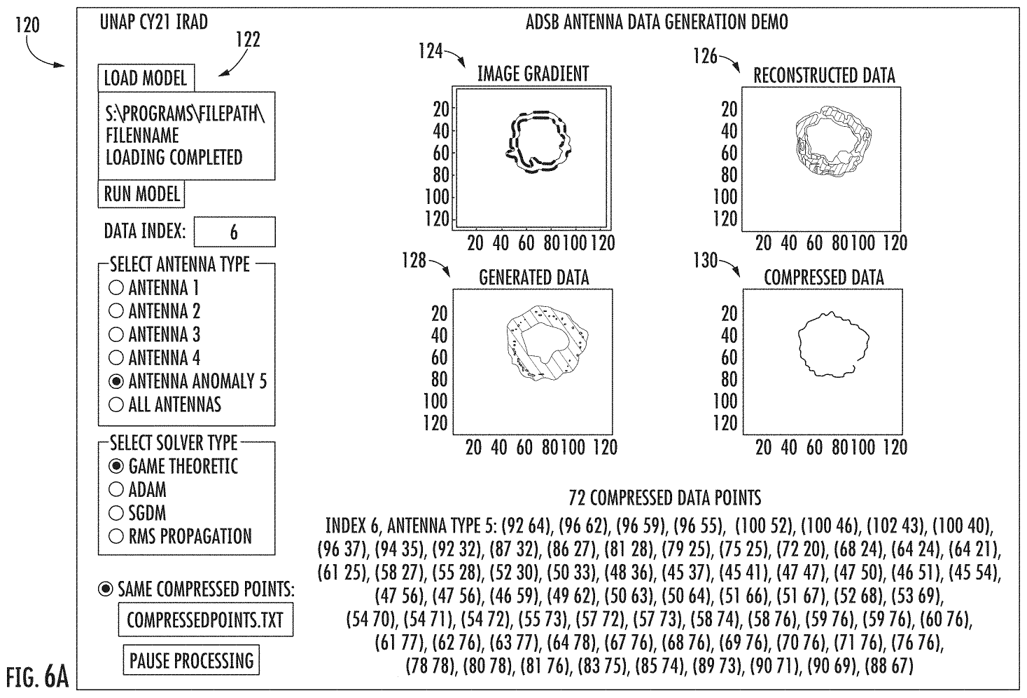

More specifically, the Z test is used to determine if the new signal distribution belongs to any existing distributions. All distributions are looped through, and the highest p value for each Z test is kept. A high p value means that the new distribution is already in the training data. Then, 1 is subtracted from these scores for H0 (FIGS. 4) and H1 (FIG. 5). The results are the ROC curves of FIG. 3.

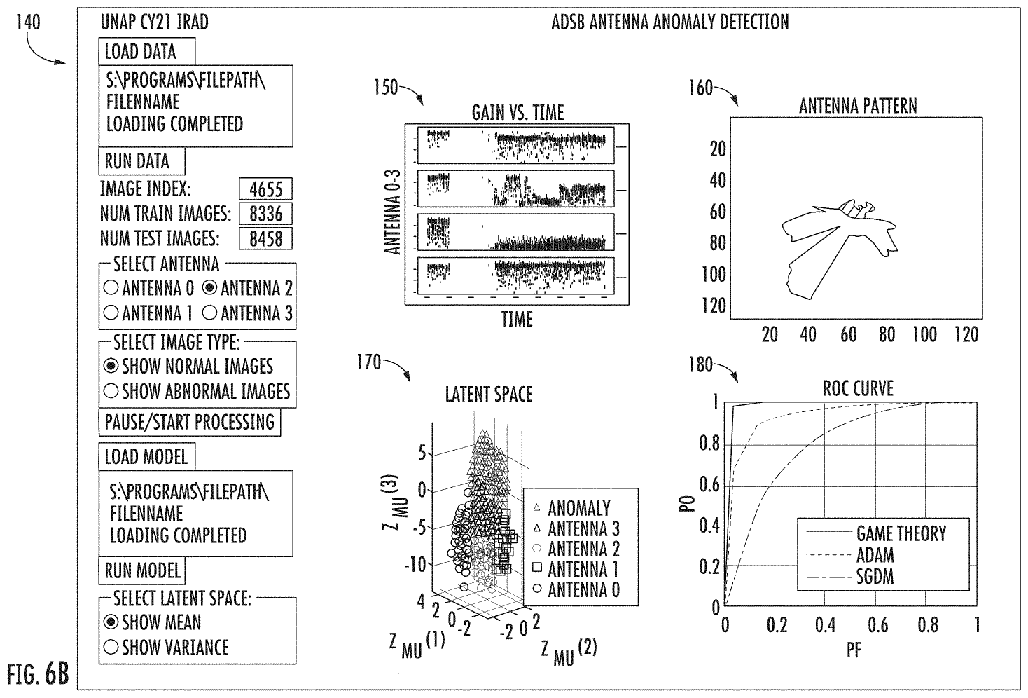

The system also either determines or enables a user to determine whether selected data for test is anomalous or not. Several visualization tools are provided. One such tool is shown in FIGS. 6A and B and is especially pertinent to antenna network anomaly detection.

An exemplary visualization tool 120 depicting the various variational autoencoder training steps in shown in FIG. 6A. Tool 120 is shown for antenna coverage, e.g., for an aviation surveillance system such as ADS-B or for other terrestrial communication systems such as a cellular network. Tool 120 has a data loading section 122 in which the model is loaded and run, an antenna type is selected, and the solver type is selected. In image gradient graph 124, the Sobel edge detector is run on raw antenna gain pattern data, resulting in the highlighted pattern shown. The preprocessed data is then run through the variational autoencoder, i.e., it is encoded and decoded, and the resulting reconstructed data is shown in graph 126. Certain select portions of the data are kept, e.g., 72 data points out of 360 (e.g., corresponding to a sampling of every five degrees), and the result is shown in generated data graph 128. Finally, the pixels along each five degrees radial line from center outward are analyzed and the pixel with the highest magnitude is kept as a compressed point and the result is shown in compressed data graph 130. Graph 130 displays the decoded synthetic data that can be used as test data.

Once the VAE is properly trained to examine live data and make determinations about whether the data is anomalous or not, it can be used in a wide variety of applications. An exemplary visualization tool 140 that aides in such a determination is shown in FIG. 6B, again concerned with antenna anomaly detection for, e.g., an aviation surveillance system such as ADS-B or a cellular network. Tool 140 depicts incoming antenna gain with respect to time plotted in graph 150. The antenna pattern under test as selected by the user is depicted in graph 160, and the user can see where that sample is located in the latent space 3-D point scatter plot shown in graph 170. Here, four different sets of normal antenna scatter plot data are depicted Antenna 0, Antenna 1, Antenna 2, and Antenna 3) as well as anomalous data. The relevant ROC curves being utilized are shown in graph 180.

Other visualization tools can enable the user to select a data sample and see where that sample is located in the latent space 3-D point scatter plot. Other visualizations are possible, from the complex to a simple blinking light to alert the analyst that something is amiss. The system itself can have anomaly thresholds pre-set and settable to self-determine whether an event rises to the level of an incident requiring a response.

In an embodiment, the neural network architecture is as follows. In the encoder layer:

```
encoderLG = layerGraph([
  • imageInputLayer(imageSize,‘Name’,‘input_encoder’,
    ‘Normalization’,'none’)
  • convolution2dLayer(3,4,‘Padding’,‘same’,‘Name’,‘conv_1’)
  • batchNormalizationLayer(‘Name’,‘BN_1’)
  • reluLayer(‘Name’,‘relu_1’)
  • maxPooling2dLayer(1,‘Stride’,1, ‘Name’,‘max1’)
  • convolution2dLayer(3,8,‘Padding’,‘same’,‘Stride’,2, ‘Name’,
    ‘conv_2’)
  • batchNormalizationLayer(‘Name’,‘BN_2’)
  • reluLayer(‘Name’,‘relu_2’)
  • maxPooling2dLayer(1,‘Stride’, 1, ‘Name’,‘max2’)
  • convolution2dLayer(3,16,‘Padding’,‘same’,‘Stride’,2,‘Name’,
    ‘conv_3’)
  • batchNormalizationLayer(‘Name’,‘BN_3’)
  • reluLayer(‘Name’,‘relu_3’)
  • maxPooling2dLayer(1,‘Stride’, 1, ‘Name’,‘max3’)
  • convolution2dLayer(3,32,‘Padding’,‘same’,‘Stride’,2,‘Name’,
    ‘conv_4’)
  • batchNormalizationLayer(‘Name’,‘BN_4’)
  • reluLayer(‘Name’,‘relu_4’)
  • maxPooling2dLayer(1,‘Stride’, 1, ‘Name’,‘max4’)
  • convolution2dLayer(3,64,‘Padding’,‘same’,‘Stride’,2,‘Name’,
    ‘conv_5’)
  • batchNormalizationLayer(‘Name’,‘BN_5’)
  • reluLayer(‘Name’,‘relu_5’)
  • maxPooling2dLayer(1,‘Stride’, 1, ‘Name’,‘max5’)
  • convolution2dLayer(3,128,‘Padding’,‘same’,‘Stride’,2,‘Name’,
    ‘conv_6’)
  • batchNormalizationLayer(‘Name’,‘BN_6’)
  • reluLayer(‘Name’,‘relu_6’)
  • fullyConnectedLayer(2*latentDim,‘Name’,‘fc’)]);
```

In the decoder layer:

```
decoderLG = layerGraph([
  imageInputLayer([1 1
  latentDim],‘Name’,‘i’,‘Normalization’,‘none’)
  transposedConv2dLayer(8, 64, ‘Cropping’, ‘same’, ‘Stride’, 8,
  ‘Name’, ‘transpose1’)
  reluLayer(‘Name’,‘relu1’)
  transposedConv2dLayer(3, 32, ‘Cropping’, ‘same’, ‘Stride’, 2,
  ‘Name’, ‘transpose2’)
  reluLayer(‘Name’,‘relu2’)
  transposedConv2dLayer(3, 16, ‘Cropping’, ‘same’, ‘Stride’, 2,
  ‘Name’, ‘transpose3’)
  reluLayer(‘Name’,‘relu3’)
  transposedConv2dLayer(3, 8, ‘Cropping’, ‘same’, ‘Stride’, 2,
  ‘Name’, ‘transpose4’)
  reluLayer(‘Name’,‘relu4’)
  transposedConv2dLayer(3, 1, ‘Cropping’, ‘same’, ‘Stride’, 2,
  ‘Name’, ‘transpose7’)
  ]);
```

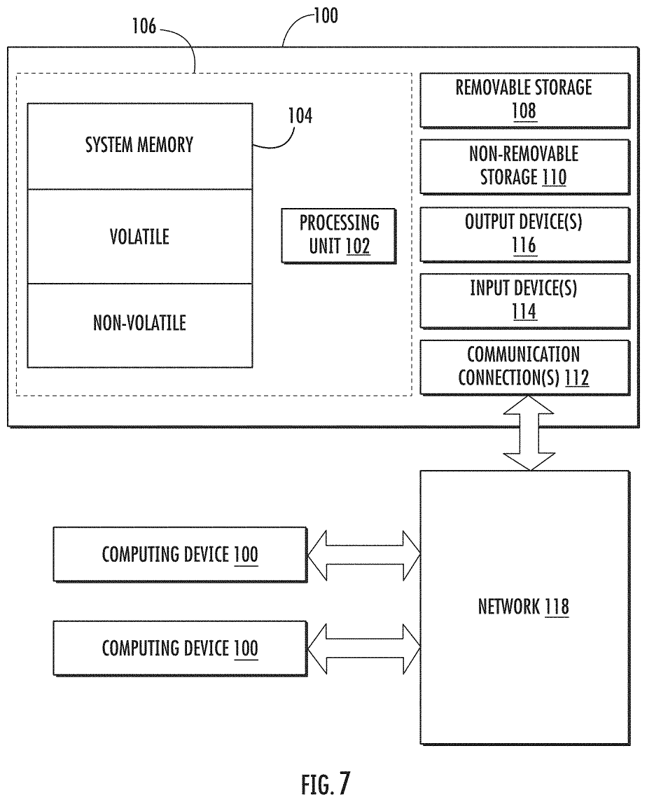

FIG. 7 depicts an exemplary computing environment in which various embodiments of the invention may be implemented and upon which various embodiments of the invention may be employed. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal electronic devices such as smart phones and smart watches, tablet computers, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 7 by dashed line 106. Computing device 100 may have additional features/functionality. For example, computing device 100 may include additional storage (removable and/or non-removable) including, but not limited to, magnetic or optical disks or tape. Such additional storage is illustrated in FIG. 5 by removable storage 108 and non-removable storage 110. Computing device 100 as used herein may be either a physical hardware device, a virtual device, or a combination thereof.

Computing device 100 typically includes or is provided with a variety of computer-readable media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, Random Access Memory (RAM), Read-Only Memory (ROM), electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 may also contain communications connection(s) 112 that allow the device to communicate with other devices. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known and therefore need not be discussed in any detail herein except as provided.

Notably, computing device 100 may be one of a plurality of computing devices 100 inter-connected by a network 118, as is shown in FIG. 7. As may be appreciated, the network 118 may be any appropriate network; each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as universal serial bus (USB) flash drives, Secure Digital (SD) memory cards, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations. In an embodiment, the system can be developed using MATLAB of MathWorks, in particular MATLAB version 2020b.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

In exemplary operation, the invention works as follows. The gain pattern for each antenna is sampled periodically at 5-degree azimuthal increments, resulting in 72 decimal numbers ranging from ˜5 dB to ˜20 dB. This data is averaged over an hour and stored in a database for later analysis. The antenna gain pattern is simply represented as an image which is input to the variational autoencoder. Each image has a metadata label such as: quadrant and status (normal or abnormal).

Antenna gain patterns are sent to the processor running the inventive VAE. The antenna gain patterns are preprocessed via an image gradient sobel edge detector, and then fed to the encoder of the VAE. The encoder takes the preprocessed data and converts it into a 20-dimensional Gaussian distribution with hidden vectors for mean and variance in the latent space. The top three dimensions are selected, and the visualization of the data is now a 3-dimensional data point in the latent space. That data point is compared to an existing previously learned scatter plot of non-anomalous conditions that had been fed through the VAE to populate the latent space. Alternatively, the data point in question is compared to an existing previously learned scatter plot of anomalous conditions that had been fed through the VAE. In either case, the further away the data point in question is from the non-anomalous plot, the more likely the data point represents an anomaly requiring attention. This is especially useful in edge cases, i.e., on the border of the normal and anomaly regions in the latent space of FIG. 2. Coming into the VAE and exiting the VAE, the data is optimized via a game theory implementation of three solvers; the solver with the least error is chosen for each quantum of data. The convolutional neural network learns by repetition in order to classify the quadrant and status (normal or abnormal). Synthetic images may be generated using the decoder portion of the VAE. Antenna gain pattern sizes in synthetic data generation is accomplished by using an attenuation multiplication factor.

The invention is not limited to the above description. For example, the invention is not limited to antenna network monitoring in telco operations or air traffic control infrastructure. It has much broader applications across an array of industries and for a variety of purposes, including IT and DevOps, manufacturing, healthcare, fintech, and in the public sector. For example, enterprise cloud providers can leverage this solution to increase visibility into their infrastructure, providing valuable insights so that they can take proactive actions. This helps with simplified operations, faster service delivery, and improved experience for end customers. The economic benefits include reduced operational expenses (OpEx), faster time to service, and significant savings in total cost of ownership (TCO).

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art. For clarity, “at least one of A or B” means either A, or B, or both A and B.

What is claimed is:

1. An antenna network anomaly detection system, comprising:
a plurality of antennas, at least a portion of the plurality of the antennas generating antenna status information; and
a processor in communication with at least one of the antennas of the portion of the plurality of the antennas and receiving the antenna status information, the processor operating a variational autoencoder that
receives the antenna status information;
optimizes the received antenna status information; and
determines or enables a user to determine whether the antenna status information qualifies as an anomaly that requires a response.

2. An antenna network anomaly detection system according to claim 1, wherein the processor compares the optimized antenna status information to at least one of non-anomalous antenna status data or anomalous antenna status data in a latent space of the variational autoencoder.

3. An antenna network anomaly detection system according to claim 2, wherein the latent space comprises an n-D point scatter plot, and wherein the further the optimized antenna status information is from the non-anomalous antenna status data in the latent space, the greater the likelihood the antenna status information represents an anomaly.

4. An antenna network anomaly detection system according to claim 3, wherein the latent space comprises a 3-D point scatter plot that includes hidden vector values.

5. An antenna network anomaly detection system according to claim 2, wherein the processor optimizes the antenna status information by generating a plurality of probabilistic models of the antenna status information and determining which of the plurality of models is optimal.

6. An antenna network anomaly detection system according to claim 5, wherein the processor determines which of the plurality of models is optimal by applying a game theoretic optimization to the plurality of models and selecting which of the plurality of models to use to generate the n-D point scatter plot in latent space.

7. An antenna network anomaly detection system according to claim 6, wherein the plurality of models includes at least two of Adam, SGDM, or RMSProp.

8. An antenna network anomaly detection system according to claim 3, further comprising:
a display; and
a user interface, the user interface enabling a user to select a data sample from the antenna status information and to see where the data sample is located in the latent space n-D point scatter plot.

9. An antenna network anomaly detection system according to claim 1, the processor further comprising an image gradient sobel edge detector that preprocesses the antenna status information prior to optimizing the antenna status information.

10. An antenna network anomaly detection system according to claim 9, wherein the image gradient sobel edge detector is configured to return a floating-point edge metric.

11. An antenna network anomaly detection system according to claim 1, wherein the plurality of antennas comprises an air traffic control surveillance system.

12. An antenna network anomaly detection system according to claim 1, wherein the antenna status information comprises at least one of a gain pattern for each antenna or the average gain pattern over time for each antenna.

13. A method of detecting antenna anomalies in a plurality of antennas, the method comprising the steps of:
generating antenna status information for at least a portion of the plurality of antennas;
receiving the antenna status information at a processor in communication with at least one of the antennas of the portion of the plurality of antennas; and
operating a variational autoencoder on the processor that is configured for
receiving the antenna status information;
optimizing the received antenna status information; and
determining or enabling a user to determine whether the antenna status information qualifies as an anomaly that requires a response.

14. A method of detecting antenna anomalies according to claim 13, further comprising the step of comparing, via the processor, the optimized antenna status information to at least one of non-anomalous antenna status data or anomalous antenna status data in a latent space of the variational autoencoder.

15. A method of detecting antenna anomalies according to claim 14, wherein the latent space includes an n-D point scatter plot, and wherein the further the optimized antenna status information is from the non-anomalous antenna status data in the latent space, the greater the likelihood the antenna status information represents an anomaly.

16. A method of detecting antenna anomalies according to claim 15, wherein the latent space includes a 3-D point scatter plot that includes hidden vector values.

17. A method of detecting antenna anomalies according to claim 14, wherein the optimizing step further comprises the steps of:
generating, via the processor, a plurality of probabilistic models of the antenna status information; and
determining, via the processor, which of the plurality of models is optimal.

18. A method of detecting antenna anomalies according to claim 17, wherein the step of determining which of the plurality of models is optimal further comprises the steps of:
applying a game theoretic optimization to the plurality of models; and
selecting which of the plurality of models to use to generate the n-D point scatter plot in latent space.

19. A method of detecting antenna anomalies according to claim 17, wherein the optimizing step is performed for at least one subset of the antenna status information.

20. method of detecting antenna anomalies according to claim 13, further comprising the step of preprocessing the antenna status information prior to optimizing the antenna status information via an image gradient sobel edge detector.

21. A method of detecting antenna anomalies according to claim 20, further comprising the step of returning a floating-point edge metric via the image gradient sobel edge detector.

22. A method of detecting antenna anomalies according to claim 13, further comprising the steps of:
implementing a 3-D p-value statistical test to measure anomaly detection accuracy; and
representing the results of the 3-D p-value statistical test with ROC curves.

23. A method of detecting antenna anomalies according to claim 22, the implementing step further comprising the steps of:
selecting a 3-D view of latent space clusters that shows the most separation of test hypotheses; and
calculating the probability of the most likely non-anomalous antenna status data to which received antenna status information might belong to latent space distribution.

24. A method of detecting antenna anomalies according to claim 13, wherein the plurality of antennas comprises an air traffic control surveillance system.

25. A method of detecting antenna anomalies according to claim 13, wherein the antenna status information comprises at least one of a gain pattern for each antenna or the average gain pattern over time for each antenna.

26. A non-transitory computer-readable storage medium, comprising one or more programs for executing a model of detecting antenna anomalies in a plurality of antennas by use of a variational autoencoder, wherein the model is configured to:
receive antenna status information from at least a portion of the plurality of antennas;
optimize the received antenna status information by use of the variational autoencoder; and
determine or enable a user to determine whether the antenna status information qualifies as an anomaly that requires a response.

27. A non-transitory computer-readable storage medium according to claim 26, wherein the model is further configured to compare, via the processor, the optimized antenna status information to at least one of non-anomalous antenna status data or anomalous antenna status data in a latent space of the variational autoencoder.

28. A non-transitory computer-readable storage medium according to claim 27, wherein the latent space includes an n-D point scatter plot, and wherein the further the optimized antenna status information is from the non-anomalous antenna status data in the latent space, the greater the likelihood the antenna status information represents an anomaly.

29. A non-transitory computer-readable storage medium according to claim 28, wherein the latent space includes a 3-D point scatter plot that includes hidden vector values.

30. A non-transitory computer-readable storage medium according to claim 27, wherein the model is further configured to optimize, via the processor, the antenna status information by generating a plurality of probabilistic models of the antenna status information and determines which of the plurality of models is optimal.

31. A non-transitory computer-readable storage medium according to claim 30, wherein the model is further configured to determine, via the processor, which of the plurality of models is optimal by applying a game theoretic optimization to the plurality of models and selecting which of the plurality of models to use to generate the n-D point scatter plot in latent space.

32. A non-transitory computer-readable storage medium according to claim 26, wherein the model is further configured to preprocess the antenna status information prior to optimizing the antenna status information via an image gradient sobel edge detector.

32. non-transitory computer-readable storage medium according to claim 32, wherein the model is further configured to return a floating-point edge metric via the image gradient sobel edge detector.

34. A non-transitory computer-readable storage medium according to claim 26, wherein the model is further configured to:
implement a 3-D p-value statistical test to measure anomaly detection accuracy; and
represent the results of the 3-D p-value statistical test with ROC curves.

35. A non-transitory computer-readable storage medium according to claim 34, wherein the model is further configured to:
select a 3-D view of latent space clusters that shows the most separation of test hypotheses; and
calculate the probability of the most likely non-anomalous antenna status data to which received antenna status information might belong to latent space distribution.

36. A non-transitory computer-readable storage medium according to claim 26, wherein the plurality of antennas comprises an air traffic control surveillance system.

37. A non-transitory computer-readable storage medium according to claim 26, wherein the antenna status information comprises at least one of a gain pattern for each antenna or the average gain pattern over time for each antenna.
